(19) United States
(12) Patent Application Publication
(10) Pub. No.: US 2022/0198467 A1
(43) Pub. Date: Jun. 23, 2022

(54) SYSTEM AND METHOD FOR SECURITIES SYNDICATION AND INVESTMENT PROMOTION

(71) Applicant: MilAdvisor, Inc., Lansdowne, VA (US)

(72) Inventors: William Militello, Naples, FL (US); John Bracken, McLean, VA (US)

(73) Assignee: MilAdvisor, Inc., Lansdowne, VA (US)

(21) Appl. No.: 17/645,605

(22) Filed: Dec. 22, 2021

Related U.S. Application Data
(60) Provisional application No. 63/199,404, filed on Dec. 23, 2020.

(51) Int. Cl. G06Q 30/00; G06Q 30/02; G06Q 40/06

(52) U.S. Cl. CPC G06Q 30/018; G06Q 40/06; G06Q 30/0204; G06Q 30/0261

(57) ABSTRACT

A system and method for providing a means securities syndication and investment promotion comprised of a system server, an issuer device, and a client device. Disclosures are appended to the end of relevant content, such as investor statements. The disclosures are generated at one or more issuer device. The disclosures are selected based on the relevant content and target audience. The relevant content and disclosures are then transmitted to the target audience.

### CROSS-REFERENCE TO RELATED APPLICATIONS

This application claims priority benefit from U.S. Provisional Application No. 63/199,404, filed on Dec. 23, 2020. The patent application identified above is incorporated here by reference in its entirety to provide continuity of disclosure.

### FIELD OF THE INVENTION

The technical field of the invention relates to automated investor communications platforms.

### BACKGROUND OF THE INVENTION

Corporations often rely on investors to raise capital to cover start-up costs, develop new products, or complete a project. A corporation may issue a security instrument to an investor in exchange for the capital. A “security instrument” grants an investor an interest in property. For example, stocks in a corporation. Bonds, mutual funds, exchange traded funds (ETFs), real estate, hedge funds, private equity funds, and commodities, may also be security instruments.

An “issuer” is a person or entity who issues or proposes to issue any security instrument. An “offeror” is a person or entity who sends a disclosure. A “disclosure” is an offering, promotion, or an advertisement for the sale of a security interest investment opportunity. An issuer may be an offeror and an offeror may be an issuer.

The SEC, and many state-level Blue Sky laws, promulgate regulations controlling how security instruments are disclosed, issued, and maintained. For instance, generally, issuers and offerors must have a license to send disclosures. Similarly, disclosures generally must be registered before being sent to a potential investor. Furthermore, the regulations control the form and subject matter in relevant content sent to existing or potential investors. “Relevant content” may be comprised of disclosures, regulatory communications, or ad hoc communications and is traditionally sent by an issuer or offeror.

A disclosure must include the financial terms of the investment opportunity and any material information that would affect the security instrument. Disclosures also include a summary of the company, industry, target customers, problem, solution, business and marketing strategy, and contact information for the issuer.

A “regulatory communication” includes investor distribution letters, K-1s, investor statements, and other financial statements. A K-1 is an IRS tax form issued annually to report an investor's share in a partnership. Regulatory communications are generally required and are generated by an issuer and transmitted to an investor through a link via text or email. Regulatory communications typically also contain personally identifiable information (PII) of an investor. As a result, additional security measures must be taken when transmitting regulatory communications to maintain the confidential nature of the information contained.

“Ad hoc communication” is the transmittal of news, third party articles, pictures, videos or presentations and accompanied narrative through a link via a text or email. Ad hoc communications are those specifically relevant to an investor or select audience of investors

A significant bar to raising capital is the inability to schedule individual time with existing and potential investors. Furthermore, all disclosures must be SEC and Blue Sky law compliant in any and all jurisdictions where they are published. Developing individually targeted and compliant disclosures is time and cost prohibitive. As a result, issuers and offerors often resort to mass e-mails with relevant content to existing and potential investors. These mass emails are largely ineffective and leave the sender with no means to follow-up with interested investors. This often times results in a loss of potential investors.

The problem of efficiently and effectively sending relevant investment content and disclosures to potential investors has been addressed by the prior art but has not been adequately resolved.

For example, U.S. Publication No. 2015/0134504 to Ryden discloses a method for performing private securities transactions and providing a data base of investment opportunities. Users may view information corresponding to the selected investment opportunity and purchase private securities. However, Ryden does not provide a means for targeted disclosures.

As another example, U.S. Publication No. 2015/0170276 to Lingam, et al. discloses a securities offering application where a securities offering may be recommended to identified investment organizations. The securities offering is offered by placing a hyperlink, an advertisement, or a banner on a member page for the investment organizations. However, Lingam does not disclose a means for generating, matching, and sending relevant content, such as regulatory communication, to an investor.

Another example, U.S. Publication No. 2010/0106578 to Allio, et al. discloses a computer implemented method for incentivizing an investor to purchase stock directly from an issuer by providing rewards. Security offerings are promoted to investors, via a banner advertisement, text link or email, a text message. However, Allio does not provide a means for matching and appending third-party disclosures to relevant content generated for an investor.

Thus, there exists a need for providing a means to individually target potential investors with relevant content in a SEC-compliant and cost effective way.

### SUMMARY OF THE INVENTION

One goal of the invention is to assist the issuer of securities in increasing the promotion of disclosures in a manner compliant with all applicable regulations. The transmittal of relevant content, such as required investor statements and investment updates, to current and prospective investors are often missed opportunities to promote or cross-promote an active disclosure. The invention takes advantage of the fact that emails and texts containing content pertinent to the recipient have a significantly higher open rate, sometimes 10-20 times the open rate, than general promotional content distributed via marketing automation or social media.

The invention automatically matches disclosures to the relevant content based on the industry associated with the relevant content, the target audience industry interests, and the industry and type of disclosure. The invention also intelligently chooses and appends disclosure tiles to relevant content to be sent to existing and potential investors. A disclosure tile is comprised of a thumb-nail view containing information about and advertising the disclosure. Appending the disclosure tiles to relevant content increases the frequency an investor sees and engages with disclosures.

Another feature of the invention allows an offeror to promote third-party disclosures. If an offeror is not the issuer of a disclosure, the invention obtains permission from the issuer of the disclosure and the offeror sending the relevant content. Once permission is granted, the disclosure is updated to the most current information available and appended to the relevant content.

In use, an offeror selects relevant content (disclosure, regulatory communication, or ad hoc communication) and then chooses the audience (potential investor, existing investor, investor group, investment group, etc.) to receive the relevant content. Once the relevant content and audience are selected, the offeror chooses which disclosure tiles they would like to promote. A promotion is generated containing the selected disclosures tiles and relevant content. A link to the promotion is then transmitted to the selected audience and displayed. Clicking on the link re-directs a user to a website landing page on the platform where the relevant content and disclosure tiles are displayed for viewing. An investor who clicks on a disclosure tile is redirected to a page displaying the full disclosure in compliance with all regulations.

The relevant content and appended disclosure tiles are visible to the recipient in an inexpensive, repeatable, and regulation compliant way.

### BRIEF DESCRIPTION OF THE DRAWINGS

FIG. 1A is a network diagram of a preferred embodiment of a system for securities syndication and investment promotion.

FIG. 1B is an exemplary diagram for a method of using relevant content to promote investment opportunities.

FIG. 1C is an exemplary diagram of database entries.

FIGS. 2A and 2B is a network communications chart of a preferred embodiment of a method of security syndication and investment promotion.

FIG. 3A is a preferred method for matching relevant content to potential investors.

FIG. 3B is a preferred method for generating a promotion.

FIG. 4 is an exemplary diagram of the investor view.

### DETAILED DESCRIPTION OF THE INVENTION

In the description that follows, like parts are marked throughout the specification and figures with the same numerals, respectively. The figures are not necessarily drawn to scale and may be shown in exaggerated or generalized form in the interest of clarity and conciseness.

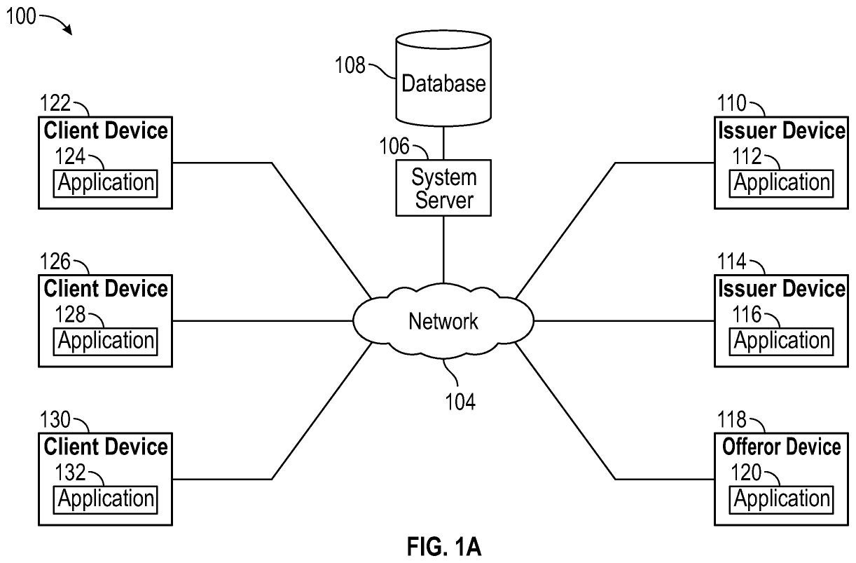

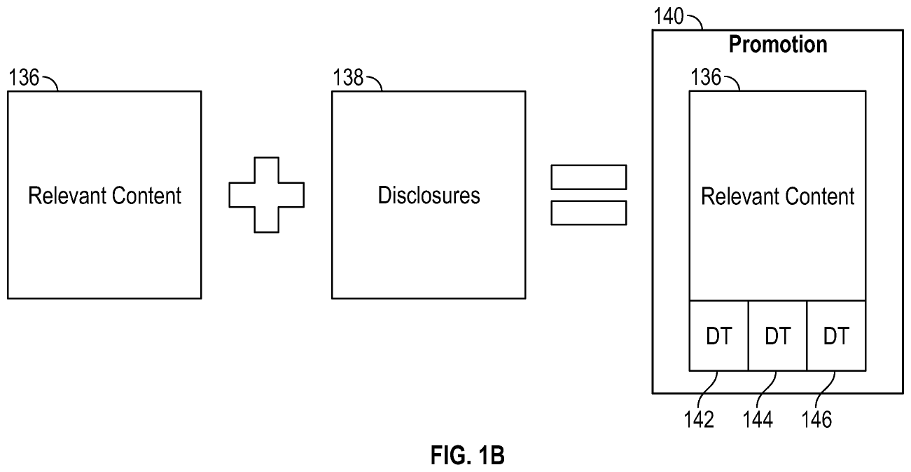

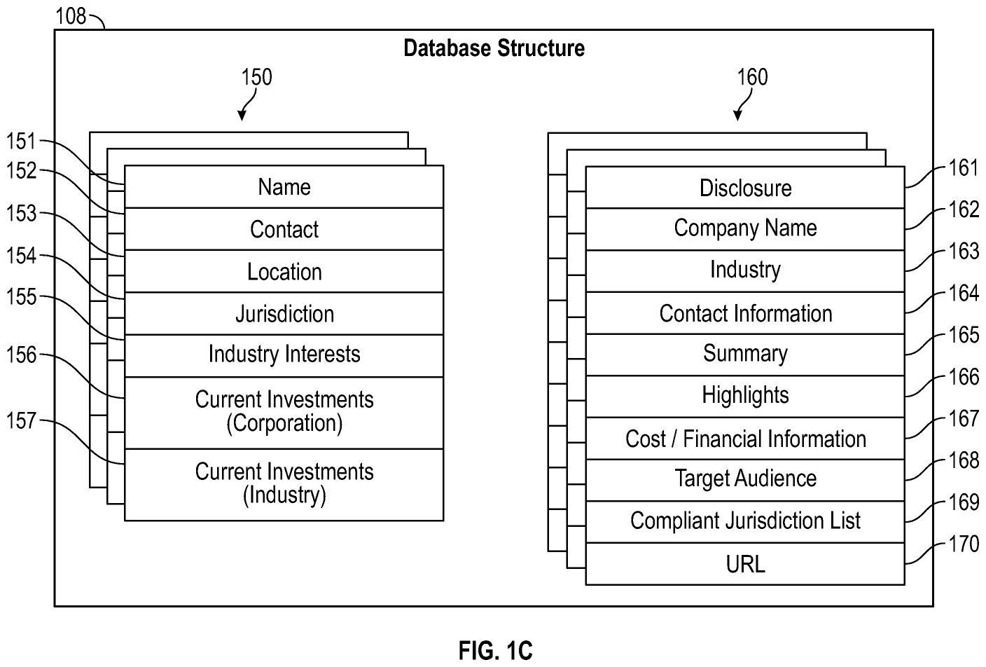

Referring then to FIG. 1A, system 100 for security syndication and investment promotion will be described.

System 100 is comprised of system server 106 and database 108. Database 108 stores client and disclosure records, as will be further described. System server 106 is connected to network 104. Network 104 is a wide area network such as the internet.

System server 106 is connected to client device 122, client device 126, and client device 130 through network 104. In a preferred embodiment, each client device is a smart device, such as a personal computer, smartphone, or tablet. Client devices 122, 126, and 130 each include applications 124, 128, and 132, respectively. Application 124, 128, and 132 may be an internet browser or a downloadable mobile application.

System server 106 is further connected to issuer device 110, issuer device 114, and offeror device 118 through network 104. In a preferred embodiment, issuer devices 110 and 114, and offeror device 118 are smart devices, such as a personal computer, smartphone, or tablet. Issuer devices 110 and 114, and offeror device 118 each include applications 112, 116, and 120, respectively. Application 112, 116, and 120 may be an internet browser or a downloadable mobile application, as previously described. It should be appreciated that an issuer device may operate as an offeror device, and an offeror device may operate as an issuer device.

Referring then to FIG. 1B, a preferred embodiment of a promotion will be described.

Promotion 140 is comprised of relevant content 136 and one or more disclosure tiles 142, 144, and 146. Relevant content 136 is comprised of a full disclosure, regulatory communication, or ad hoc communication. Disclosures 138 are comprised of disclosures matched to the relevant content and target audience, as will be further described. Each disclosure tile is associated with one of disclosures 138, as will be further described.

Referring then to FIG. 1C, contents of database 108, will be further described. In a preferred embodiment, the database is implemented with appropriate record cards and queries to accomplish the features required. Database 108 includes client records 150 and disclosure records 160.

Client records 150 are each comprised of multiple data fields associated with each client device. The data fields include client name 151, contact information 152, location 153, jurisdiction 154, investment industries of interest 155, current investment information 156, such as corporate name and current investments by industry 157. In alternate embodiments, additional data fields may be stored in each of the client records.

Disclosures 138 are each comprised multiple data fields associated with each disclosure. In a preferred embodiment, the data fields include disclosure 161 which is comprised of all the necessary disclosure details needed to comply with federal and state regulations. The data fields further include company name 162, industry 163, contact information 164, summary of the investment opportunity 165, highlights 166, investment cost and financial information 167, target audience 168, compliant jurisdiction list 169, and URL 170. Compliant jurisdiction list 169 includes all jurisdictions where the disclosure meets all applicable regulations. Target audience 168 includes types of investors, such as individual investors or investor groups. Highlights 166 may include the investment goal, current capital raised, and average rate of return. Investment cost and financial information 167 must include the equity share offered, expected rate of return, cost, and any dividend offerings. URL 170 is automatically assigned to the disclosure by the system and redirects a user to a disclosure details page, as will be further described.

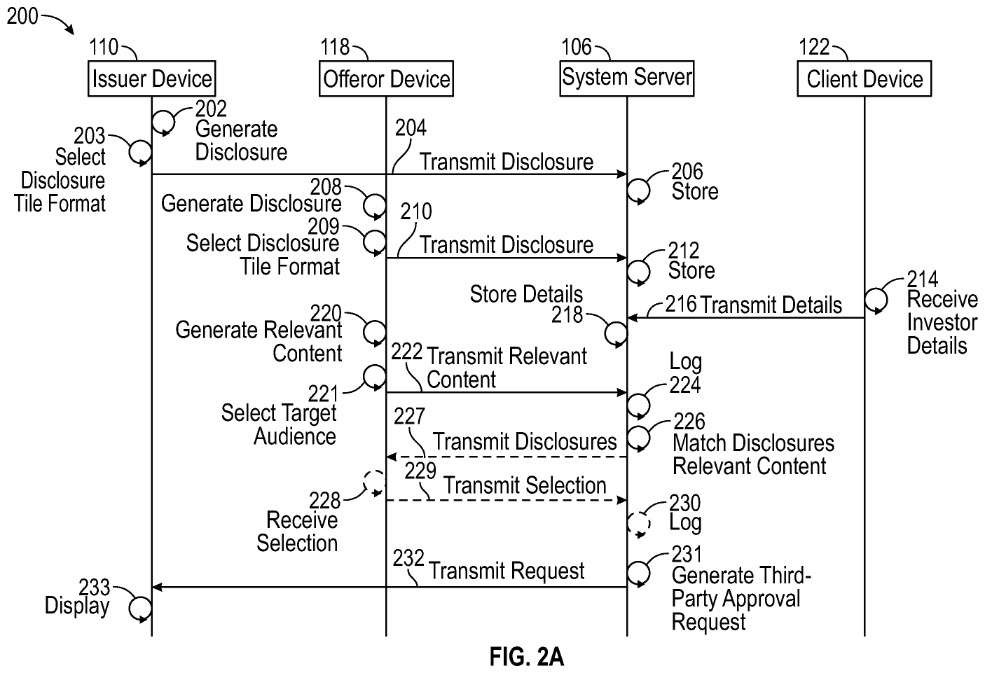

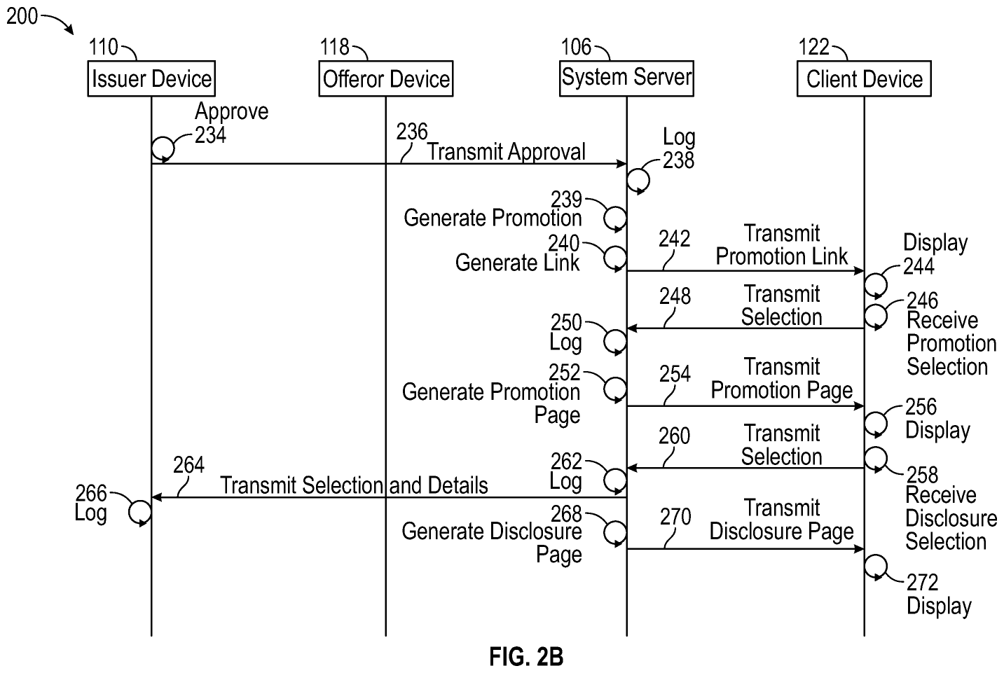

Referring then to FIGS. 2A and 2B, method 200 for promoting disclosures will be described.

At step 202, a disclosure is generated at issuer device 110. In a preferred embodiment, the disclosure includes all the details required under federal and state regulations, as previously described. In other embodiments, the disclosure may be compliant in only a subset of the possible jurisdictions.

At step 203, a disclosure tile format is selected at issuer device 110. A disclosure tile is a link which may contain an image or summary advertising the disclosure. In a preferred embodiment, at this step a user selects the format of the disclosure tile and may optionally upload an image.

At step 204, the disclosure and disclosure tile format are transmitted to system server 106. At step 206, the disclosure and disclosure tile format are stored in the database. In a preferred embodiment, the disclosure is stored as a record and the URL is created and associated with the disclosure and linked to the disclosure tile.

At step 208, offeror device 118 generates a disclosure, as previously described. At step 209, a disclosure tile format is selected. At step 210, the disclosure and disclosure tile format are transmitted to system server 106. At step 212, the disclosure is stored as a record and the URL is created and linked to the disclosure tile, as previously described.

At step 214, client device 122 receives information related to potential investor, such as contact information, current investments, and industry of interest, as previously described. At step 216, the investor information is transmitted to the system server. At step 218, the investor information is stored as a record in the database.

At step 220, relevant content is generated at offeror device 118. Relevant content is comprised of a disclosure, regulatory communication, or ad hoc communications, as previously described. In a preferred embodiment, relevant content includes the name of the offeror and the investment industry. At step 221, offeror device receives a selection of the target audience for the relevant content, such as an existing individual investor, an existing investment group, or a potential investor and potential investor group.

At step 222, the relevant content is transmitted to system server 106. At step 224, the relevant content is logged by the system server. At step 226, the system server matches disclosures to the relevant content, the appropriate jurisdiction, and target audience, as will be further described.

Optionally, at step 227, a list of the disclosures matched is transmitted to offeror device 118. Optionally at step 228, offeror device 118 receives a selection of one or more disclosures from the list. Optionally at step 229, the selection is transmitted to system server 106. Optionally at step 230, the selected disclosures are logged by the system.

At step 231, the system server generates a third-party disclosure approval request. In a preferred embodiment, the offeror must receive approval to promote a third-party disclosure. At step 232, the approval request is transmitted to issuer device 110.

At step 233, the approval request is displayed at issuer device 110.

At step 234, an approval is received at issuer device 110. Optionally, at this step, updates to the disclosure may be included in the approval. At step 236, the approval and any updates are transmitted to system server 106. At step 238, the approval is logged and the disclosure is updated with the most relevant information.

At step 239, a promotion containing the relevant content and disclosure tiles for the selected disclosures is generated at system server 106, as will be further described. At step 240, a link to the promotion is generated. At step 242, the promotion link is transmitted to client device 122. At step 244, the link is displayed at the client device.

At step 246, client device 122 receives a selection of the promotion link. At step 248, the selection is transmitted to system server 106. At step 250, the system server logs the selection. At step 252, the system server generates the promotion page which displays the relevant content and disclosure tiles. At step 254, the promotion page is transmitted to client device 122. At step 256, the promotion page is displayed at the client device.

At step 258, client device 122 receives a selection of a disclosure tile displayed in the promotion. At step 260, the selection is transmitted to system server 106. At step 262, the system logs the selection.

At step 264, the disclosure selection and investor details are transmitted to an issuer device of the disclosure, such as issuer device 110. At step 266, the issuer device logs the interested investor details.

At step 268, the system server generates a disclosure details page, as will be further described. At step 270, the disclosure details page is transmitted to client device 122. At step 272, the disclosure details are displayed at the client device.

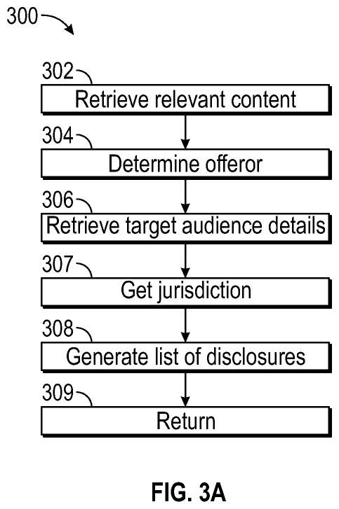

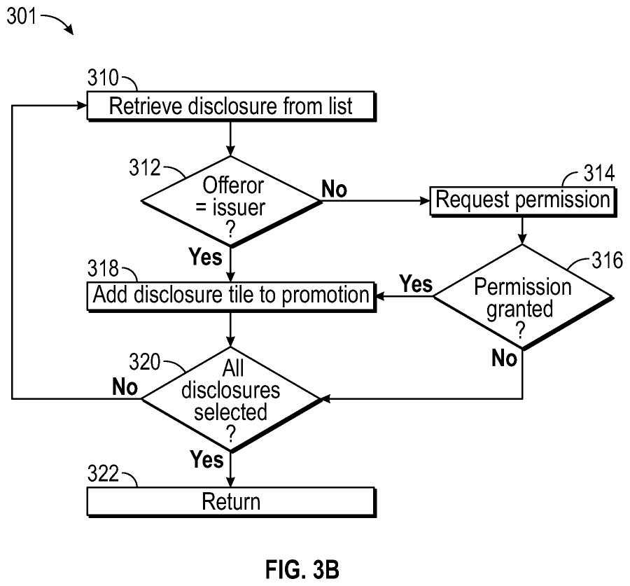

Referring then to FIG. 3A, preferred method 300 for matching disclosures to relevant content of step 226 will be further described.

At step 302, the relevant content is retrieved from the database. At step 304, the offeror is determined. At step 306, the client record is retrieved for each recipient in the target audience. At step 307, the jurisdiction of each recipient in the target audience is determined from the client records.

At step 308, a list of relevant disclosures is generated by retrieving all disclosure records from the database having the same jurisdiction designation and the same industry as listed in the client record.

At step 309, the method returns.

Referring then to FIG. 3B, preferred method 301 for generating a promotion of step 239 will be further described.

At step 310, a relevant disclosure is selected from the list of relevant disclosures. At step 312, the system determines if the offeror is the same as the issuer of the disclosure. If not, the method proceeds to step 314. If so, the method proceeds to step 318.

At step 314, an approval request is generated and sent to the issuer of the selected disclosure. At step 316, the system queries if an approval is granted. If yes, the method proceeds to step 318. If not, the method proceeds to step 320.

At step 318, the disclosure tile associated with the selected disclosure is added to the promotion.

At step 320, the system queries if all relevant disclosures have been selected. If not, the method returns to step 310. If yes, the method proceeds to step 322. In a preferred embodiment, between one and three disclosure tiles may be appended to a promotion. In alternate embodiments, a greater or lesser number of disclosure tiles may be appended.

At step 322, the method returns the promotion with all of the selected disclosure tiles appended.

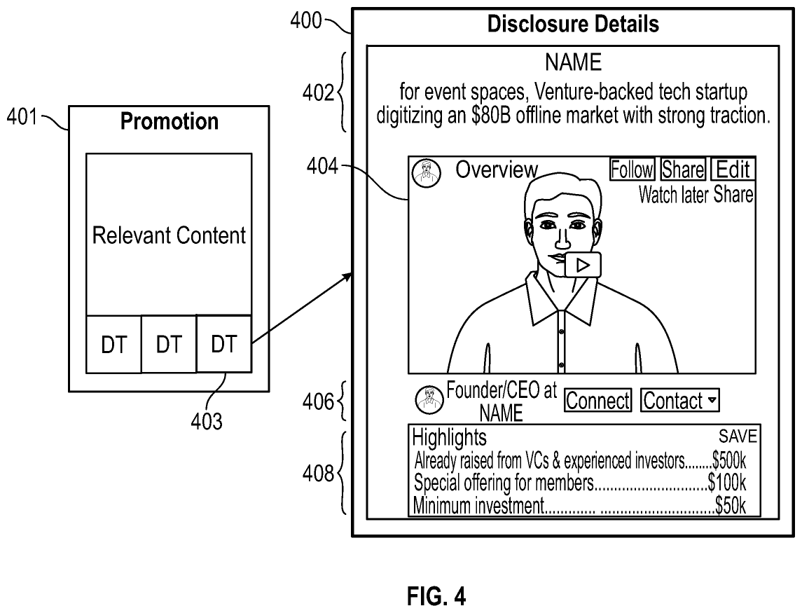

Referring then to FIG. 4, a preferred embodiment of disclosure page 400 will be described.

Disclosure page 400 is displayed at the client device when disclosure tile 403 is selected from promotion 401. In a preferred embodiment, the disclosure page includes title section 402, narrative 404, contact information 406, and highlights section 408, and any other information required by state and federal regulations.

Title section 402 is comprised of the company name and a brief summary of the company and investment goal. In a preferred embodiment, narrative 404 may be comprised of video or paragraph pitching the investment opportunity and providing greater detail.

Contact information 406 provides the contact information and provides a link to connect with the contact point. Highlights section 408 includes a summary of the investment, such as the capital already raised, the capital goal, minimum investment amount, and any special investment options.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

1. A system for disclosing investment opportunities comprising:
a system server, connected to a network;
an issuer device, connected to the system server through the network;
an offeror device, connected to the system server through the network;
a client device, connected to the system server through the network;
a set of processors in the system server, the issuer device, the client device, and the offeror device;
a set of memories, each memory of the set of memories operably connected to at least one processor in the set of processors;
the set of memories, including a set of instructions that, when executed causes the system to perform the steps of:
receiving, at the system server, a set of disclosures;
receiving, at the system server, a set of client information;
generating a match condition between a disclosure of the set of disclosures and a subset of client information from the set of client information;
generating, at the offeror device, a communication;
generating a promotion based on the match condition and the communication; and,
transmitting the promotion to the client device.

2. The system of claim 1 wherein the set of client information further comprises at least one of a name, a contact information, a location, a jurisdiction, a industry of interest list, and a current investment list.

3. The system of claim 2 wherein each disclosure of the set of disclosures further comprises at least one of a group of a disclosure, a company name, an industry, a contact information, a summary, a funding goal, a current amount funded, a rate of return, a target audience, a compliant jurisdiction, and a link.

4. The system of claim 3 wherein the step of generating a match condition further comprises:
retrieving a jurisdiction and an industry of interest from the set of client information;
deriving a set of relevant disclosures from the set of disclosures based on the jurisdiction and the industry of interest;
generating a tile for a relevant disclosure of the set of relevant disclosures; and,
appending the tile to the communication.

5. The system of claim 4 wherein the set of instructions further comprise instructions that when executed cause the system to:
activate, at the system server, a link for the tile;
receive a link selection at the client device; and,
transmit a relevant disclosure, of the set of relevant disclosures, to the client device based on the link selection.

6. The system of claim 4 wherein a set of three tiles is appended to the communication.

7. The system of claim 4 wherein the set of instructions further comprises instructions that when executed cause the system to:
transmit the set of relevant disclosures to the offeror device;
receive, at the offeror device, a selection of a selected disclosure from the set of relevant disclosures; and,
transmit the selected disclosure to the system server.

8. The system of claim 7 wherein the set of instructions further comprises instructions that when executed cause the system to:
determine an issuer for the selected disclosure; and,
if the issuer is not associated with the offeror device;
generate, by the system server, an approval request based on the selected disclosure; and,
receive, at the system server, an approval based on the approval request.

9. The system of claim 8 wherein the set of instructions further comprises instructions that when executed cause the system to:
generate an automatic approval if the issuer is associated with the offeror device.

10. The system of claim 1 wherein the communication further comprises at least one of a group of a second disclosure, a regulatory communication, and an ad hoc communication.

11. A method for disclosing investment opportunities comprising:
providing a system server, connected to a network;
providing an issuer device, connected to the system server through the network;
providing an offeror device, connected to the system server through the network;
providing a client device, connected to the system server through the network;
providing a set of processors in the system server, the issuer device, the client device, and the offeror device;
providing a set of memories, each memory of the set of memories operably connected to at least one processor in the set of processors;
the set of memories, including a set of instructions that, when executed causes the steps of:
receiving, at the system server, a set of disclosures;
receiving, at the system server, a set of client information;
generating a match condition between a disclosure of the set of disclosures and a subset of client information from the set of client information;
generating, at the offeror device, a communication;
generating a promotion based on the match condition and the communication; and,
transmitting the promotion to the client device.

12. The method of claim 11 wherein the set of client information further comprises at least one of a name, a contact information, a location, a jurisdiction, an industry of interest list, and a current investment list.

13. The method of claim 12 wherein each disclosure of the set of disclosures further comprises at least one of a group of a disclosure, a company name, an industry, a contact information, a summary, a funding goal, a current amount funded, a rate of return, a target audience, a compliant jurisdiction, and a link.

14. The method of claim 13 wherein the step of generating a match condition further comprises:
Retrieving a jurisdiction and an industry of interest from the set of client information;
deriving a set of relevant disclosures from the set of disclosures based on the jurisdiction and the industry of interest;
generating a tile for a relevant disclosure of the set of relevant disclosures; and,
appending the tile to the communication.

15. The method of claim 14 wherein the set of instructions further comprise instructions that when executed cause the further steps of:
activate, at the system server, a link for the tile;
receive a link selection at the client device; and,
transmit a relevant disclosure, of the set of relevant disclosures, to the client device based on the link selection.

16. The method of claim 14 wherein a set of three tiles is appended to the communication.

17. The method of claim 14 wherein the set of instructions further comprises instructions that when executed cause the further steps of:
transmit the set of relevant disclosures to the offeror device;
receive, at the offeror device, a selection of a selected disclosure from the set of relevant disclosures; and,
transmit the selected disclosure to the system server.

18. The method of claim 15 wherein the set of instructions further comprises instructions that when executed cause the further steps of:
determine an issuer for the selected disclosure; and,
if the issuer is not associated with the offeror device;
generate, by the system server, an approval request based on the selected disclosure; and,
receive, at the system server, an approval based on the approval request.

19. The method of claim 18 wherein the set of instructions further comprises instructions that when executed cause the further steps of:
generate an automatic approval if the issuer is associated with the offeror device.

20. The method of claim 11 wherein the communication further comprises at least one of a group of a second disclosure, a regulatory communication, and an ad hoc communication.
